(19) United States
(12) Patent Application Publication
(10) Pub. No.: US 2008/0226527 A1
(43) Pub. Date: Sep. 18, 2008

(54) Earning carbon credits by using aquaculture to sequester carbon dioxide

(76) Inventors: Patrick J. Casey, Kumeu (NZ); David Gold, Kumeu (NZ); Nicholas Mills, Kumeu (NZ)

Correspondence Address: PATRICK R. SCANLON;PRETI FLAHERTY BELIVEAU & PACHIOS LLP, ONE CITY CENTER, PORTLAND, ME, 04112-9546, US

(21) Appl. No.: 12/074,868

(22) Filed: Mar. 6, 2008

Related U.S. Application Data
(60) Provisional application No. 60/905,775, filed on Mar. 8, 2007.

(51) Int. Cl. B01D 53/62

(52) U.S. Cl. 423/232

(57) ABSTRACT

A method of earning carbon credits includes sequestering carbon dioxide by cultivating aquatic organisms that have carbon-containing shells and obtaining carbon credits based on the sequestered carbon dioxide.

### CROSS REFERENCES TO RELATED APPLICATIONS

This application claims the benefit of U.S. Provisional Application Ser. No. 60/905,775, filed Mar. 8, 2007.

### BACKGROUND OF THE INVENTION

The earth is warmed by gases in the atmosphere that are commonly referred to as greenhouse gases. Greenhouse gases include water vapor, carbon dioxide, methane, nitrous oxide, and ozone. Some greenhouse gases occur naturally and some are the result of human activity. A large amount of carbon dioxide (CO₂) in the atmosphere is the result of human activity, such as the burning of fossil fuels.

Greenhouse gases work by stopping and reflecting back some of the warmth emitted from earth. This is known as the greenhouse effect. Without greenhouse gases the earth would not be warm enough to sustain life, so such gases are an important component of the atmosphere. However, the concentration of several greenhouse gases has increased over time, and it is widely accepted that this increase has led to global warming. Accordingly, global concern exists on the effect of greenhouse gases on earth's weather and ecosystems.

Effects attributed to global warming are loss of ice shelves and the related increase in sea level, changes in rainfall patterns, and increased intensity and frequency of extreme weather events. Serious economic costs are the result. In an effort to mitigate these costs many countries are now looking at ways of reducing greenhouse gases in the atmosphere. A greenhouse gas identified as being a primary concern is carbon dioxide. It is estimated that atmospheric carbon dioxide has increased by 100 parts per million over the past 200 years (i.e., post industrialization).

There are two principal ways of dealing with atmospheric carbon dioxide. One approach is to reduce emissions of carbon dioxide. For example, limiting the burning of fossil fuels will decrease the amount of carbon dioxide released into the atmosphere. The other approach is to increase efforts to remove or absorb atmospheric carbon dioxide. Systems that remove carbon from the atmosphere are known as carbon sinks. The most common carbon sinks are the oceans, soil, plants and other organisms that use photosynthesis to remove carbon from the atmosphere by incorporating it into biomass.

Forests are the most frequently talked about type of carbon sink. The use of trees to absorb carbon dioxide has been extensively studied and theorized. However, although carbon dioxide is absorbed into trees for some time, it is not permanently sequestered from the environment. This carbon is subject to release back into the atmosphere as a result of the trees burning or decaying. Another important carbon sink, one that is perhaps less well known, is the ocean. The way the ocean works as a sink is carbon dioxide dissolves into it, removing it from the atmosphere. The concentration of carbon dioxide in the ocean increases proportionately as atmospheric carbon dioxide increases. However, as with some other carbon sinks, the carbon absorbed into the oceans can eventually find its way back into the ecosystem.

Carbon sequestered in carbon sinks can be the basis for earning “carbon credits” that can be traded as part of an emissions trading scheme. Emission trading schemes typically utilize a cap-and-trade arrangement wherein a governing body sets a cap on allowable emissions and issues emission permits that represent the right to emit a specific amount of a pollutant. Participants that do not have enough emission permits to cover their emissions can purchase credits from participants that have extra permits. Participants are also able to purchase credits from entities that have earned credits by creating a net reduction in greenhouse gases. The Kyoto Protocol to the United Nations Framework Convention on Climate Change (an international environmental treaty aimed at reducing emissions of greenhouse gases) has established a framework for emissions trading schemes. The European Union Emission Trading Scheme, which is modeled on the Kyoto Protocol, is the largest emissions trading scheme. Various emissions trading schemes have also been in use within the United States for some time.

Carbon credits are awarded to entities that have produced a verifiable reduction in atmospheric carbon. In addition to being traded under an emissions trading scheme, carbon credits can be purchased by companies or individuals who wish to lower their carbon footprint on a voluntary basis (i.e., outside of an emissions trading scheme). Carbon credits must be validated or certified, typically by a governing body, before they can be traded meaningfully in a marketplace. For instance, the Kyoto Protocol has established the Clean Development Mechanism (CDM), which validates and measures projects to ensure they produce authentic benefits to the environment.

### SUMMARY OF THE INVENTION

In one embodiment, the present invention provides a method of earning carbon credits that includes sequestering carbon dioxide by cultivating aquatic organisms that have carbon-containing shells and obtaining carbon credits based on the sequestered carbon dioxide.

### DETAILED DESCRIPTION OF THE INVENTION

The invention generally relates to using aquaculture farming systems to effect long-term sequestration of atmospheric carbon dioxide and thereby assist in the reduction of greenhouse gases. By sequestering the carbon dioxide, such an aquaculture farming system may earn carbon credits that can be traded.

One aspect of this method is to provide for the long-term sequestration of carbon dioxide through aquaculture, particularly aquaculture involving aquatic organisms, such as shellfish, crustaceans and mollusks, which have carbon-containing shells. As used herein, the term “shell” is intended to include any hard, rigid outer layer, including exoskeletons, armours, carapaces, etc., developed by a wide variety of different animal species. Aquaculture is the cultivation or farming of aquatic organisms, typically under controlled conditions. Ponds, pens, tanks or other enclosures are commonly used. Various interventions in the process, such as regular stocking, feeding, protection from predators, etc., are often employed to enhance growth and survival.

The cultivation of aquatic organisms having carbon-containing shells removes carbon dioxide from the atmosphere in the following manner. Seawater (or fresh water as the case may be) containing dissolved carbon dioxide is ingested by these aquatic organisms. This carbon dioxide is converted within the aquatic organisms, and, with the addition of other elements becomes calcium carbonate (CaCO₃), the major component of the shell. In other words, the aquatic organisms convert ingested carbon dioxide into calcium carbonate in order to grow their shells. Thus, the carbon dioxide ingested by the aquatic organisms is effectively stored in the shell. The carbon stored in the shells is thus removed from the water that the aquatic organisms are cultivated in. By removing dissolved carbon dioxide from the water, the generation of shells increases the carbon absorption ability of the water. In turn, the water is thus able to absorb more carbon dioxide from the atmosphere. The cultivation of aquatic organisms is preferably carried out in bodies of water that are capable of acting as a carbon sink, such as oceans, rivers and lakes. As dissolved carbon dioxide is absorbed into the aquatic organisms, the oceans, rivers and lakes are able to absorb more carbon dioxide from the atmosphere. Thus, the more aquatic organisms that are cultivated, the greater the ability of these bodies of water to act as carbon sinks. The carbon sequestered in this way stays “locked up” and is effectively removed from the atmosphere essentially indefinitely because shells do not break down.

Another aspect of the method is obtaining or earning carbon credits based on the amount of carbon sequestered in shells produced by the cultivation of aquatic organisms. That is, the total amount of shells produced by an aquaculture system will represent a specific amount of sequestered carbon. This sequestered carbon dioxide can be measured and used to earn carbon credits. The earned carbon credits can be traded, either as part of an emissions trading scheme or with companies or individuals acting outside of an emissions trading scheme. Generally, entities that heavily emit carbon will want to purchase credits so that they may offset the carbon debits earned through their emissions.

Typically, obtaining carbon credits for the carbon sequestered in the shells will require having the amount of sequestered carbon validated or certified by an appropriate governing body. Such validation will typically involve determining the amount of carbon dioxide sequestered by the aquaculture activity and applying to the governing body for validation of a corresponding number of carbon credits. In many emissions trading schemes, one ton of carbon absorption ability equates to one carbon credit. Determining the amount of sequestered carbon dioxide can include using credible and verifiable methods to measure or calculate the amount of carbon sequestered from the quantity of shells cultivated.

The cultivated aquatic animals can be used for other uses in addition to earning carbon credits. For instance, the aquatic organisms will be harvested for meat. The meat produced from the aquaculture can be used as a food source for both humans and animals. Carbon ingested by those eating the shellfish will be converted and stored as skeletal carbon. The meat can also be converted into vegetative carbon through use as fertilizer for plant and tree growth. Bio-ethanol and bio-diesel could be produced from the meat developed from the aquaculture, providing another source of renewable, eco-friendly energy for commercial use.

The shells recovered after the meat has been harvested also have a number of potential uses. For instance, the shells can be used as paving material for roads, paths, tracks, driveways, parking lots, etc. The recovered shells can be used for insulation heating of viticulture (e.g., crushed shells can be used to insulate the roots of grape vines and absorb heat from the sun which is later reflected back towards the grapes). Such ancillary uses provide a purpose for the shells while they are providing long term sequestration of carbon.

The present invention produces the environmental benefit of reducing greenhouse gases. Other environmental benefits exist from using aquaculture for carbon sequestration. One positive side effect is that aquaculture farming systems provide a natural filtration system filter and detoxify sea and fresh water. As more aquaculture farming systems are developed, more environmental detoxification occurs. Another benefit is the creation of meat can be an alternate to intensive agricultural practices that result in large amounts of greenhouse gases being emitted into the atmosphere. The creation of environmentally friendly bio-fuels as a natural by product of these aquaculture farming systems will also have a positive effect on the environment.

While specific embodiments of the present invention have been described, it should be noted that various modifications thereto could be made without departing from the spirit and scope of the invention as defined in the appended claims.

What is claimed is:

1. A method of earning carbon credits, said method comprising cultivating aquatic organisms that convert carbon dioxide into calcium carbonate to grow shells.

2. The method of claim 1 further comprising using an aquaculture farming system to cultivate aquatic organisms.

3. The method of claim 2 aquaculture farming system is operated in a body of water capable of acting as a carbon sink.

4. The method of claim 1 further comprising obtaining carbon credits based on the amount of carbon dioxide converted into calcium carbonate.

5. The method of claim 4 further comprising trading said carbon credits.

6. The method of claim 4 wherein obtaining carbon credits includes applying to a governing body for validation of carbon credits.

7. A method of earning carbon credits, said method comprising:
sequestering carbon dioxide by cultivating aquatic organisms having carbon-containing shells; and
obtaining carbon credits based on said sequestered carbon dioxide.
The method of claim 7 further comprising trading said carbon credits.

8. The method of claim 7 wherein obtaining carbon credits includes determining the amount of carbon dioxide sequestered by cultivating aquatic organisms and applying to an appropriate governing body for validation of a corresponding number of carbon credits.

9. The method of claim 8 wherein determining the amount of carbon dioxide sequestered includes calculating said amount from the quantity of shells cultivated.

10. The method of claim 7 wherein cultivating aquatic organisms is carried out in a body of water capable of acting as a carbon sink.

11. The method of claim 7 further comprising harvesting meat from said aquatic organisms.

12. The method of claim 7 further comprising providing a use for shells recovered from said aquatic organisms.

13. The method of claim 12 wherein said recovered shells are used as paving material.

14. The method of claim 12 wherein said recovered shells are used as insulation material.
